(19) United States
(12) Patent Application Publication
(10) Pub. No.: US 2014/0003643 A1
(43) Pub. Date: Jan. 2, 2014

(54) HOUSING FOR A HEARING INSTRUMENT, METHOD FOR PRODUCING THE HOUSING AND HEARING INSTRUMENT

(71) Applicant: Siemens Medical Instruments Pte. Ltd., Singapore (SG)

(72) Inventor: FRANK NAUMANN, ERLANGEN (DE)

(21) Appl. No.: 13/928,943

(22) Filed: Jun. 27, 2013

(30) Foreign Application Priority Data
Jun. 27, 2012 (DE) 10 2012 210 944.7

(51) Int. Cl. H04R 25/00

(52) U.S. Cl. CPC H04R 25/65
USPC 381/328

(57) ABSTRACT

A housing for a hearing instrument, a method for producing a housing for a hearing instrument and a hearing instrument embodied to be worn in an auditory canal of a user, are provided. A channel which is disposed in the housing is embodied as a through-opening for sound and air. This channel is incorporated in a housing wall. The integration of such a channel in the housing wall enables a space-saving structure of the hearing instrument so that a microphone can be firmly attached to the housing wall. Advantageously, the shape and position of the channel may be configured individually for the user following an acoustic optimization process and the microphone may be made of silicon.

### CROSS-REFERENCE TO RELATED APPLICATION

This application claims the priority, under 35 U.S.C. §119, of German Patent Application DE 10 2012 210 944.7, filed Jun. 27, 2012; the prior application is herewith incorporated by reference in its entirety.

### BACKGROUND OF THE INVENTION

### Field of the Invention

The invention relates to a housing for a hearing instrument, a method for producing the housing and a hearing instrument, in particular a hearing device, to be worn in an auditory canal of a user.

Hearing instruments can be embodied as hearing devices. A hearing device is used to supply a hearing-impaired person with acoustic ambient signals, which are processed and amplified so as to compensate for and/or treat a respective hearing impairment. The hearing device is formed, in principle, of one or a number of input transducers, a signal processing facility, an amplification facility and an output transducer. The input transducer is generally a sound receiver, e.g. a microphone and/or an electromagnetic receiver, e.g. an induction coil. The output signal generator is generally realized as an electroacoustic converter, e.g. a miniature loudspeaker, or as an electromechanical converter, e.g. a bone conduction earpiece. The output signal generator is also referred to as an earpiece or receiver. The output signal generator generates output signals which are routed to the ear of the patient and are intended to generate a hearing perception in the patient. The amplifier is generally integrated in the signal processing facility. Power is supplied to the hearing device by a battery integrated in the hearing device housing. The important components of a hearing device are generally disposed on a printed circuit board as a circuit carrier and/or connected thereto.

Aside from hearing devices, which are used to compensate for diminished hearing ability, which is usually referred to as hard-of-hearing, hearing instruments can also be embodied as so-called tinnitus maskers. Tinnitus maskers are used to treat patients with tinnitus. They generate acoustic output signals which depend on the respective hearing impairment and, depending on the active principle, also on the ambient noises, with the output signals possibly contributing to reducing the perception of interfering tinnitus or other ear noises. The term hearing instrument is also to be understood below as including tinnitus maskers and other such devices.

Hearing devices are known in various basic housing configurations. In the case of ITE (In-the-Ear) hearing devices, a housing containing all of the functional components including a microphone and a receiver is, for the most part, worn in the auditory canal. CiC (Completely-in-Canal) hearing devices are similar to ITE hearing devices, but are not worn completely in the auditory canal. In the case of BTE (Behind-the-Ear) hearing devices, a housing with components such as a battery and a signal processing facility is worn behind the ear and a flexible sound tube, also known as a tube, routes the acoustic output signals of a receiver from the housing to the auditory canal. RiC-BtE (Receiver-in-Canal Behind-the-Ear) hearing devices are similar to BTE hearing devices but the receiver is, however, worn in the auditory canal and, instead of a sound tube, a flexible earpiece tube routes electrical signals, instead of acoustic signals, to the receiver which is attached to the front of the earpiece tube. Common to all housing configurations is the aim for the smallest possible housing, so as to increase wearing comfort and reduce the visibility of the hearing device for cosmetic reasons.

In order to realize a space-saving embodiment, when manufacturing deep-ear-canal hearing devices, a microphone is often used to convert acoustic ambient signals into electrical signals, with the microphone not being directly connected to the housing of the hearing device. A tube is used there to forward the acoustic ambient signals from the microphone opening to the microphone itself.

U.S. Patent Application Publication No. US 2010/0128915 A1 discloses a hearing instrument including a housing, which offers a recess for a microphone, so that the microphone can be integrated as firmly as possible into the housing.

### BRIEF SUMMARY OF THE INVENTION

It is accordingly an object of the invention to provide a housing for a hearing instrument, a method for producing the housing and a hearing instrument, which overcome the hereinafore-mentioned disadvantages of the heretofore-known housings, methods and instruments of this general type and which offer a firm hold for a microphone and provide a space-saving construction which benefits from the state of the housing geometries in question.

With the foregoing and other objects in view there is provided, in accordance with the invention, a housing for a hearing instrument configured to be worn in an auditory canal of a user and to receive a microphone. The housing comprises a housing wall and a channel configured as a through-opening incorporated in the housing wall for conducting sound and air.

With the objects of the invention in view, there is also provided a method for producing a housing according to the invention. The method comprises determining a position of the microphone in the housing, determining a position and/or a structure of the channel, and manufacturing the housing with the channel.

With the objects of the invention in view, there is furthermore provided a hearing instrument configured to be worn in an auditory canal of a user. The hearing instrument comprises a housing according to the invention.

The housing, which is constructed with the object of the invention in mind, is described below. Features, advantages or alternative embodiments mentioned in this description are likewise also transferred to the other claimed subject matters and vice versa. In other words, the claims, which focus on a housing for instance, are also developed with the features which are described or claimed in conjunction with a method. In this way, the corresponding functional features of the method are embodied by corresponding modules, in particular by hardware modules.

The invention makes use of the possibility of integrating a channel for forwarding the acoustic ambient signals from the microphone opening to the microphone into the housing wall in a simple manner.

This configuration is particularly advantageous for a more compact construction of the housing itself and thus of the entire hearing instrument to be realizable since additional space is obtained inside the housing.

In accordance with another particularly suitable feature of the invention, the position and/or shape of the channel in the housing are configured individually to the user. The type or nature of the course of the channel and the state of the channel thus represent further parameters in an acoustic optimization process. Differing requirements from different users can be taken into account in this case to a significant degree.

In accordance with a further feature of the housing of the invention, a microphone is fastened to the wall of the housing with a fastener or fastening device. A firm hold is thereby ensured and the displacement of the microphone in the interior of the housing is prevented.

In accordance with an added feature of the invention, the microphone is alternatively accommodated in the interior of the housing by positioning the microphone in a pocket fastened to the housing wall by using a fastener or fastening device.

In accordance with a suitable additional feature of the invention, the microphone is manufactured from silicon. Such microphones are particularly robust, for instance in the case of soldering processes.

In accordance with a concomitant feature of the invention, an opening in the housing wall is used as an interface between the microphone and the channel. This enables sound transfer to also be adjusted and optimized to the user.

Other features which are considered as characteristic for the invention are set forth in the appended claims.

Although the invention is illustrated and described herein as embodied in a housing for a hearing instrument, a method for producing the housing and a hearing instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional view of a hearing instrument with a microphone glued to a housing wall; and

FIG. 2 is a cross-sectional view of a hearing instrument with a microphone disposed in a pocket fastened to the housing wall.

### DESCRIPTION OF THE INVENTION

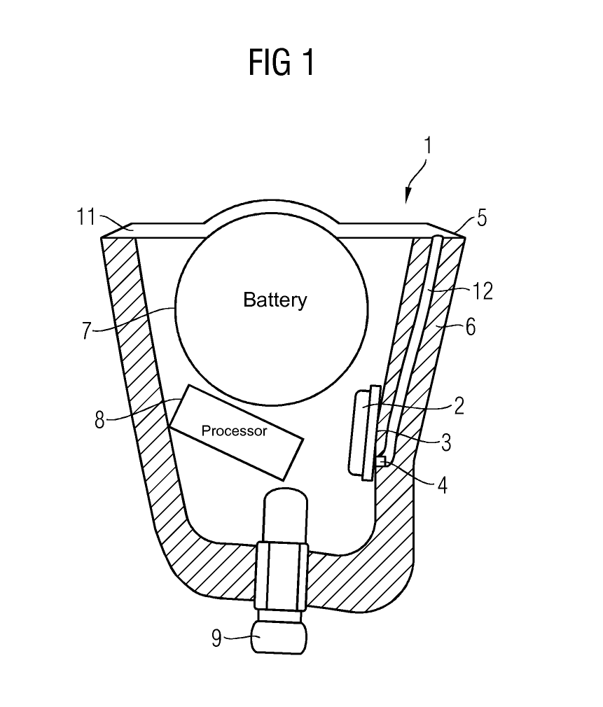

Referring now to the figures of the drawings in detail and first, particularly, to FIG. 1 thereof, there is seen a housing 11 for a hearing device 1, which is embodied to be worn in an auditory canal of a user and has a microphone 2, a battery 7, a signal processing unit 8 and a receiver 9.

The microphone 2 is used to convert acoustic ambient signals into electrical signals, the battery 7 to supply power, the signal processing unit 8 to process and amplify acoustic signals and the receiver 9 to generate acoustic output signals for a human ear. The receiver 9 is disposed on a side of the housing 11 which faces the eardrum (proximal), if the hearing device is inserted into an auditory canal. It is accommodated in the housing 11 in a space-saving manner.

The components are usually connected electrically to one another. The housing 11 has a shape which allows for insertion into the auditory canal of the user. The shape can be individually adjusted to the contour of the user.

The microphone 2 is fastened to a housing wall 6 using a fastener or fastening device 3. Furthermore, the microphone 2 is connected to a channel 12 having an opening 4. The channel 12 is incorporated in the housing wall 6 and forwards the acoustic ambient signals from a microphone opening 5 to the microphone 2. Such an integration of this channel 12 into the housing 11 allows for the possibility of constructing a smaller hearing instrument 1. A cost saving also results from the material savings. The fastener or fastening device 3 is, for instance, a liquid adhesive.

It is also possible, for instance as a result of an acoustic optimization process, to configure the position and/or shape of the channel 12 in the housing wall individually to the user and to adjust the same to special hearing requirements. Furthermore, this process is also possible for a housing 11 which was itself already adjusted to the ear geometry of the user. The opening 4 in the housing wall 6 can also be constructed individually in this process with respect to the size and/or angle of the opening.

The invention also includes a method for producing a housing 11 for a hearing instrument 1 having such a channel 12, in which the position of the microphone 2 in the housing 11 is determined. Furthermore, an individual position and/or structure of the channel 12 is determined, for instance with an acoustic optimization process. The housing 11 is then produced with the individually determined channel 12. The determination of the position and/or structure of the channel 12 can also take place prior to determining the position of the microphone 2 in the housing 11.

The housing 11 is manufactured, for instance, by using stereolithography methods. In this case, a silicon impression of the ear, which is determined for the purpose of wearing the hearing instrument, is firstly digitalized with a 3D scanner and a virtual housing individually attuned hereto is produced by using CAD applications. In this way, the required components are positioned virtually. The data record is then calculated for the stereolithography device and a prototype is generated.

Instead of stereolithography, the housing 11 can also be generated, for instance, by selective laser sintering, using DLP printers or other 3D printers.

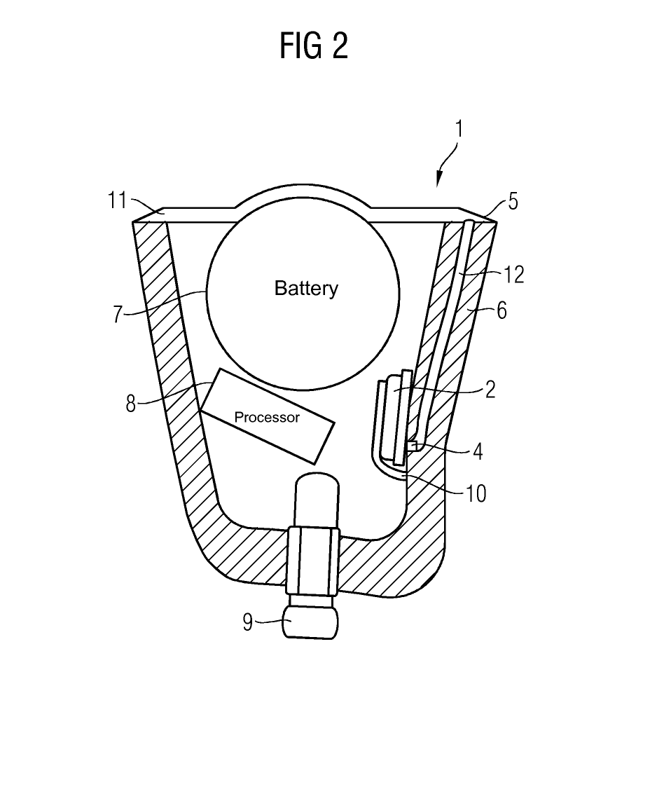

FIG. 2 shows an alternative configuration of the microphone 2 on the housing wall 6. In this case, the microphone 2 is accommodated in a pocket 10 attached to the housing wall 6. As a result, there is no need to fasten the microphone 2 itself to the housing wall 6.

Although the invention is illustrated and described in more detail by referring to the preferred exemplary embodiments, the invention is not restricted by the disclosed examples and other variations can be derived therefrom by the person skilled in the art without departing from the scope of protection of the invention.

In summary, the invention relates to a housing for a hearing instrument, a method for producing a housing for a hearing instrument, as well as to a hearing instrument, which is embodied so as to be worn in an auditory canal of a user. In this case, a channel which is disposed in the housing is embodied as a through-opening for sound and air. This channel is incorporated in the housing wall. The integration of such a channel into the housing wall allows for a space-saving structure of the hearing instrument, so that a microphone can be firmly attached to the housing wall. According to an advantageous embodiment, the shape and position of the channel are configured individually to the user following an acoustic optimization process and the microphone is made of silicon.

1. A housing for a hearing instrument configured to be worn in an auditory canal of a user and to receive a microphone, the housing comprising:
a housing wall; and
a channel configured as a through-opening incorporated in said housing wall for sound and air.

2. The housing according to claim 1, wherein at least one of a position or a shape of said channel in said housing wall are configured individually for the user.

3. The housing according to claim 1, which further comprises a microphone connected to said housing wall by a fastener.

4. The housing according to claim 1, which further comprises a pocket fastened to the housing by a fastener, and a microphone positioned in said pocket.

5. The housing according to claim 3, wherein said microphone is manufactured from silicon.

6. The housing according to claim 4, wherein said microphone is manufactured from silicon.

7. The housing according to claim 3, wherein said housing wall has an opening configured as an interface between said microphone and said channel.

8. The housing according to claim 4, wherein said housing wall has an opening configured as an interface between said microphone and said channel.

9. A method for producing a housing according to claim 1, the method comprising the following steps:
determining a position of the microphone in the housing;
determining at least one of a position or a structure of the channel; and
manufacturing the housing with the channel.

10. A hearing instrument configured to be worn in an auditory canal of a user, the hearing instrument comprising:
a housing according to claim 1.
